(19) United States
(12) Patent Application Publication
(10) Pub. No.: US 2024/0391138 A1
(43) Pub. Date: Nov. 28, 2024

(54) HYBRID-TYPE MANUFACTURING METHOD OF FILAMENT FOR 3D PRINTER

(71) Applicant: KI YOUNG KIM, Gumi-si (KR)

(72) Inventor: KI YOUNG KIM, Gumi-si (KR)

(21) Appl. No.: 18/336,110

(22) Filed: Jun. 16, 2023

(30) Foreign Application Priority Data
May 26, 2023 (KR) 10-2023-0068378

(51) Int. Cl. B29B 11/16; B29B 11/10; B33Y 70/10

(52) U.S. Cl. CPC B29B 11/16; B29B 11/10; B33Y 70/10; B29K 2077/00; B29K 2307/04

(57) ABSTRACT

Proposed is a manufacturing method of a filament for a 3D printer. The manufacturing method of a filament for a 3D printer includes forming a filament by covering carbon fiber with a thermoplastic resin. and forming a resin layer on a surface of the filament, which is formed in the filament forming.

### CROSS-REFERENCE TO RELATED APPLICATION

The present application claims priority to Korean Patent Application No. 10-2023-0068378, filed May 26, 2023, the entire contents of which are incorporated herein for all purposes by this reference.

### BACKGROUND OF THE INVENTION

### Field of the Invention

The present disclosure relates generally to a hybrid-type manufacturing method of a filament for a 3D printer. More particularly, the present disclosure relates to a hybrid-type manufacturing method of a filament for a 3D printer in which carbon fiber is impregnated with a thermoplastic resin solution liquefied by a solvent to form a filament in which a thermoplastic resin is evenly penetrated into the carbon fiber, and a surface resin layer is formed by applying a thermoplastic resin to the surface of the filament formed in the application of the solvent method by using an extruder.

A 3D printer was developed for the purpose of making a prototype before commercializing a product by a company, and was developed from an initial stage limited to plastic materials and expanded to the scope of application thereof to nylon and metal materials. The 3D printer entered not only the stage of an industrial prototype, but also a commercialization stage in many ways.

The 3D printing method is divided into a stacking method of stacking up a material layer by layer and a cutting-type processing method of cutting a large mass.

The stacking method is a method in which a material is melted while passing through a heated extruder, and the material flowing through a nozzle is laminated on an output plate to form a required shape. The stacking method is similar to a method of a glue gun used for bonding at home.

As the material of the 3D printer, a thin plastic thread called a filament is used.

Meanwhile, in order to improve mechanical properties such as the strength of a filament for a 3D printer, a carbon fiber filament is being manufactured by adding carbon fiber to the filament.

Conventionally, in order to manufacture the carbon fiber filament, a thermoplastic resin is extruded into the filament by using an extruder.

FIG. 1 is a micrograph of a cross section of a carbon fiber filament for a 3D printer manufactured by a conventional method.

Referring to FIG. 1, it can be seen that in the cross section of the carbon fiber filament, there is an empty space not filled with a thermoplastic resin and that carbon fiber is unevenly distributed.

Accordingly, when there is an empty space not filled with the thermoplastic resin, the strength of the filament is lowered, and when the carbon fiber is non-uniformly distributed, the characteristics of the product are not inconsistent.

Meanwhile, few thermoplastic resin layers are formed on the surface of the carbon fiber filament of FIG. 1.

When filaments are stacked by a 3D printer, a thick resin layer is required to be formed on the surface of each of the filaments to improve the stacking strength of the filaments.

Accordingly, the development of a new manufacturing method of a filament for a 3D printer, in which a thermoplastic resin is evenly filled inside a filament, carbon fiber is evenly distributed therein, and a thick resin layer is formed on the surface of the filament, is urgently needed.

### Document of Related Art

(Patent Document 1) Korean Patent Application Publication No. 10-2021-0020309

### SUMMARY

Accordingly, the present disclosure has been made keeping in mind the above problems occurring in the related art, and the present disclosure is intended to propose a manufacturing method of a filament for a 3D printer in which a thermoplastic resin is evenly filled inside a filament for a 3D printer so that an empty space is not defined in the filament.

In addition, the present disclosure is intended to propose a manufacturing method of a filament for a 3D printer in which carbon fiber is evenly distributed inside a filament for a 3D printer.

Furthermore, the present disclosure is intended to propose a manufacturing method of a filament for a 3D printer in which a thick thermoplastic resin layer is formed on the surface of a filament for a 3D printer.

Additionally, the present disclosure is intended to propose a manufacturing method of a filament for a 3D printer in which a filament for a 3D printer is continuously manufactured.

In addition, the present disclosure is intended to propose a manufacturing method of a filament for a 3D printer in which the manufacturing time of a filament for a 3D printer is reduced.

In order to achieve the above objectives, according to one aspect of the present disclosure, there is provided a manufacturing method of a filament for a 3D printer, the method including: forming a filament by covering carbon fiber with a thermoplastic resin; and forming a resin layer on a surface of the filament, which is formed in the filament forming.

In addition, the filament forming of the present disclosure may include: liquefying a thermoplastic resin by immersing the thermoplastic resin in a solvent; impregnating the carbon fiber with a thermoplastic resin solution; and drying the impregnated carbon fiber obtained in the carbon fiber impregnating.

In addition, the thermoplastic resin of the present disclosure may be polyamide, and the solvent may be formic acid.

In addition, in the drying of the present disclosure, the filament obtained in the carbon fiber impregnating may be dried by blowing hot air to the filament.

In addition, in the resin layer forming of the present disclosure, the resin layer may be formed on the surface of the filament formed in the filament forming by extruding a thermoplastic resin from an extruder.

In addition, the resin layer forming of the present disclosure may be performed by using the extruder in which a conical discharge part is formed continuously on an end part of a cylindrical body, an inlet hole through which a solid thermoplastic resin is supplied is formed in one side of the body, a discharge hole is formed in a longitudinal direction of the extruder in an end part of the discharge part, a through hole is formed in a horizontal direction across the discharge hole, and a rotating screw which is electrically heated is mounted in the body, and while the filament formed in the filament forming is horizontally moved at a predetermined speed through the through hole, a thermoplastic resin extruded by the screw may continuously form the resin layer on the surface of the filament.

The manufacturing method of a filament for a 3D printer according to the present disclosure has the effect that a thermoplastic resin is evenly filled inside a filament for a 3D printer.

In addition, the manufacturing method of a filament for a 3D printer according to the present disclosure has the effect that carbon fiber is evenly distributed inside a filament for a 3D printer.

Furthermore, the manufacturing method of a filament for a 3D printer according to the present disclosure has the effect that the stacking strength of filaments during 3D printing is improved.

In addition, the manufacturing method of a filament for a 3D printer according to the present disclosure has the effect that a filament for a 3D printer is continuously manufactured to increase production efficiency.

Furthermore, the manufacturing method of a filament for a 3D printer according to the present disclosure has the effect that the manufacturing time of a filament for a 3D printer is reduced.

In addition to the above effects, specific effects of the present disclosure will be described together while explaining specific details for implementing the present disclosure.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a micrograph of a cross section of a carbon fiber filament for a 3D printer manufactured by a conventional method;

FIG. 2 is a flowchart of a manufacturing method of a filament for a 3D printer according to the present disclosure;

FIG. 3 is a view illustrating the manufacturing method of a filament for a 3D printer according to the present disclosure; and

FIG. 4 is an SEM picture of a carbon fiber filament for a 3D printer according to the present disclosure.

### DETAILED DESCRIPTION

Hereinafter, the embodiment of the present document will be described with reference to the accompanying drawings. However, this is not intended to limit the technology described in this document to a specific embodiment, and it should be understood that various modifications, equivalents, and/or alternatives of the embodiment of this document are included. In connection with the description of the drawings, like reference numerals may be used for like components. In addition, expressions such as “first” and “second” used in this document may modify various elements regardless of order and/or importance, and are used only to distinguish one element from another element but do not limit the corresponding components. For example, “first part” and “second part” may represent different parts regardless of order or importance. For example, without departing from the scope of the claims described in this document, the first component may be named as the second component, and similarly, the second component may also be named as the first component.

In addition, terms used in this document are used only to describe a specific embodiment, and may not be intended to limit the scope of other embodiments. A singular expression may include a plural expression unless the context clearly dictates otherwise. Terms used herein, including technical or scientific terms, may have the same meanings as commonly understood by those skilled in the art described in this document. Among the terms used in this document, terms defined in a general dictionary may be interpreted to have the same or similar meaning as meaning in the context of the related art, and unless explicitly defined in this document, are not interpreted as deal or excessively formal meanings. In some cases, even terms defined in this document cannot be construed to exclude the embodiment of the present document.

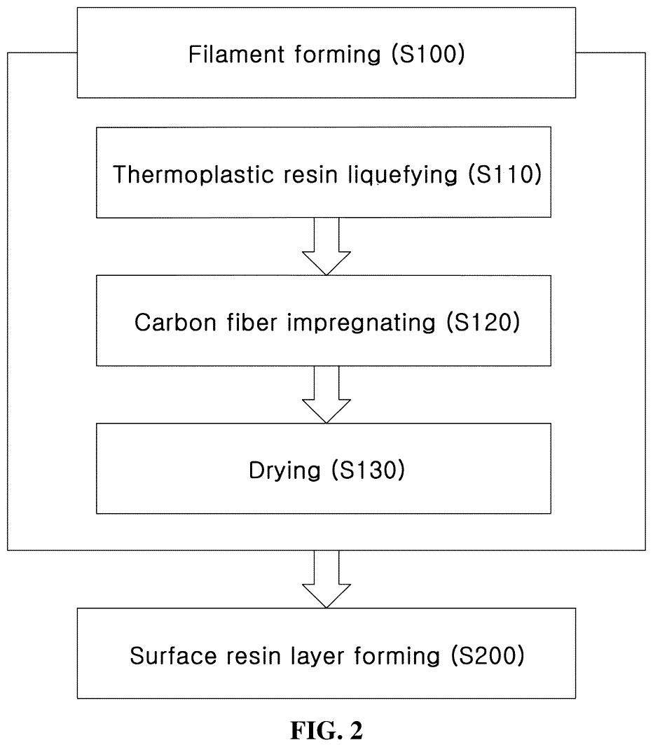

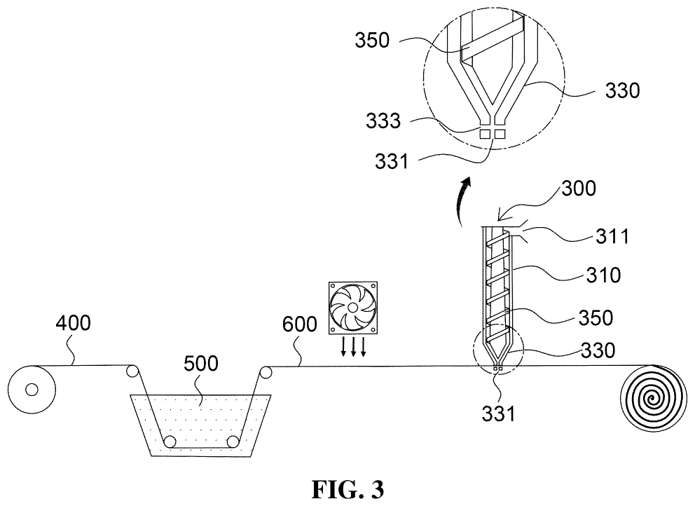

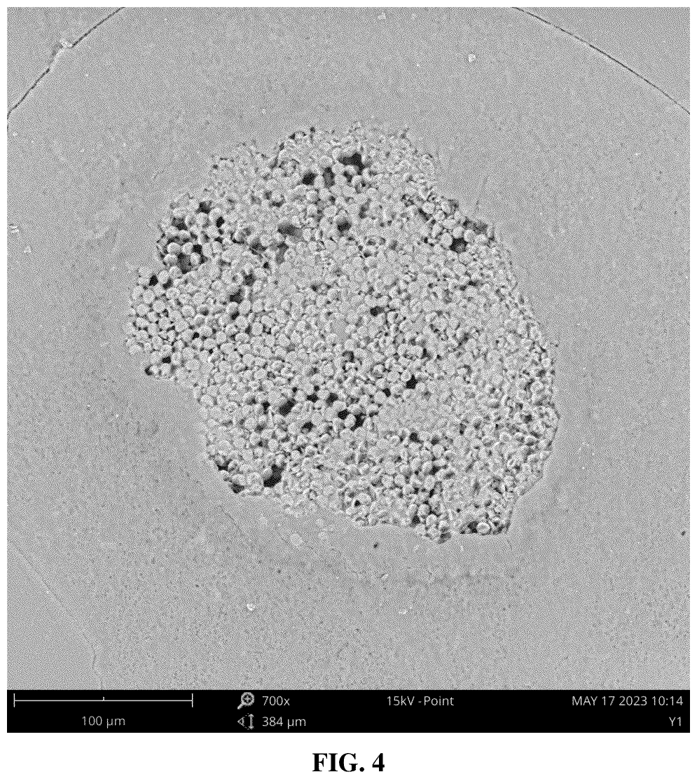

FIG. 2 is a flowchart of a manufacturing method of a filament for a 3D printer according to the present disclosure, FIG. 3 is a view illustrating the manufacturing method of a filament for a 3D printer according to the present disclosure, and FIG. 4 is a micrograph of a carbon fiber filament 600 for a 3D printer according to the present disclosure.

The manufacturing method of a filament for a 3D printer according to the present disclosure will be described with reference to FIGS. 2 to 4.

The manufacturing method of a filament according to the present disclosure includes forming a filament at S100 and forming a surface resin layer at S200.

In the present disclosure, in manufacturing a filament for a 3D printer, a solvent method and a melt extrusion method are used together.

That is, in the filament forming at S100, the solvent method is used, and in the resin layer forming at S200, the melt extrusion method is used.

A reason for applying the two different methods will be described in detail below.

The filament forming at S100 is a step of forming a filament by covering carbon fibers 400 with a thermoplastic resin.

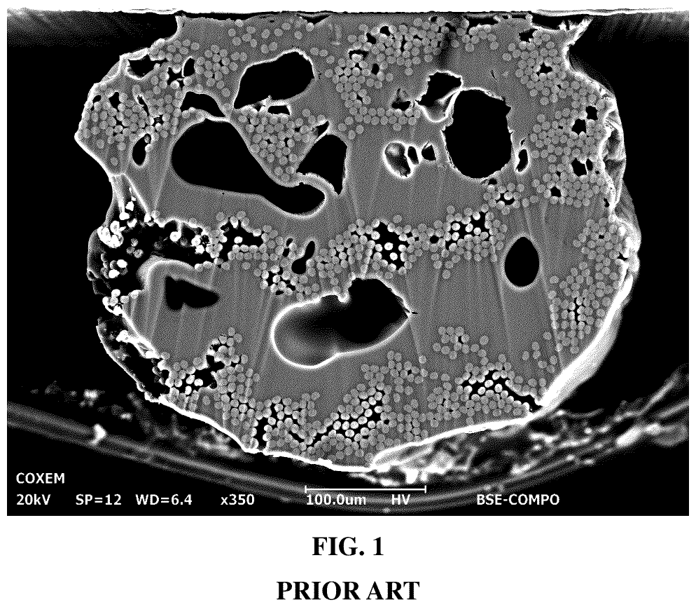

Conventionally, the filament forming at S100 was performed by using the melt extrusion method, but as illustrated in FIG. 1, there is empty space between the carbon fibers 400 that is not filled with thermoplastic resin, and the carbon fibers 400 are non-uniformly distributed, so satisfactory mechanical properties of a filament cannot be satisfied.

Accordingly, in the present disclosure, instead of using the melt extrusion method, the solvent method of impregnating the carbon fiber 400 by melting a thermoplastic resin in a solvent is applied.

The filament forming at S100 according to the present disclosure will be described in detail with reference to FIG. 3.

The filament forming at S100 includes liquefying a thermoplastic resin at S110, impregnating carbon fiber at S120, and drying at S130.

The thermoplastic resin liquefying at S110 is the step of liquefying a thermoplastic resin by immersing the thermoplastic resin in a solvent.

In the present disclosure, polyamide is used as a thermoplastic resin, and formic acid is used as a solvent.

However, the thermoplastic resin and solvent are not limited to the chemical substances, but various thermoplastic resins and solvents suitable for the resins may be employed.

The carbon fiber impregnating at S120 is a step of impregnating the carbon fiber 400 with a thermoplastic resin solution 500.

The surface of the carbon fiber 400 impregnated with the thermoplastic resin solution 500 is covered by the thermoplastic resin solution 500, and the thermoplastic resin solution 500 has good flowability to fill the surroundings of the carbon fiber 400 without empty space.

As a result, it is possible to prevent the strength reduction of a conventional carbon fiber filament 600 due to internal empty space generated in the conventional carbon fiber filament 600, and due to the improved flowability of a thermoplastic resin solution, the carbon fiber 400 is uniformly distributed in the thermoplastic resin solution 500, and the characteristics of products can be standardized.

The drying S130 is a step of drying the filament obtained in the carbon fiber impregnating at S120. The filament is dried by blowing hot air of 100 degrees Celsius or more for about 1 to 5 minutes with a blower fan.

The solvent method has the advantage of efficiently infiltrating the thermoplastic resin solution 500 into an area around the carbon fiber 400, but has the disadvantage of requiring a lot of time to dry the impregnated filament.

Meanwhile, in the case of a filament manufactured by a conventional melt extrusion method, there is a problem in that the stacking strength of the filament is weak because a thermoplastic resin layer is not sufficiently formed on the surface of the filament.

Accordingly, in the present disclosure, the conventional problem is solved by adding the resin layer forming at S200.

The resin layer forming at S200 is a step of forming a resin layer on the surface of the filament formed in the filament forming at S100 by extruding a thermoplastic resin from an extruder 300.

In the present disclosure, to improve productivity, the resin layer forming at S200 is performed continuously.

To this end, the extruder 300 is manufactured to have a structure illustrated in FIG. 3.

The structure of the extruder 300 will be described in detail.

In the extruder 300, a conical discharge part 330 is formed continuously on an end part of a cylindrical body 310.

An inlet hole 311 through which a solid thermoplastic resin is supplied is formed in one side of the body 310, and a discharge hole 331 is formed in a longitudinal direction of the extruder 300 in an end part of the discharge part 330.

In addition, a through hole 333 is horizontally formed across the discharge hole 331, and a rotating screw 350 which is electrically heated is mounted inside the body 310.

While the filament formed in the filament forming at S100 is moved horizontally at a predetermined speed through the through hole 333, a thermoplastic resin extruded by the screw 350 is applied to the surface of the filament so that a resin layer is continuously formed.

As a result, the thermoplastic resin is coated thick on the outer circumferential surface of the filament to form a thermoplastic resin layer.

In the melt extrusion method, molten thermoplastic resin cannot be infiltrated into a filament so that there is no empty space inside the filament, but can quickly coat the surface of the filament. Accordingly, in the present disclosure, the melt extrusion method is adopted in the resin layer forming at S200.

According to the present disclosure, in the filament forming at S100, the solvent method is used, and in the resin layer forming at S200, the melt extrusion method is used, thereby preventing the formation of empty space inside a filament and allowing a resin layer to be rapidly formed on the surface of a filament.

FIG. 4 is an SEM picture of a carbon fiber filament for a 3D printer according to the present disclosure.

Referring to FIG. 4, it can be seen that a resin layer is formed on the edge of the filament, empty space that is not filled with thermoplastic resin does not exist on a center portion thereof, and carbon fibers covered by thermoplastic resin are evenly distributed.

The present disclosure relates generally to the hybrid-type manufacturing method of a filament for a 3D printer. More particularly, the present disclosure relates to a hybrid-type manufacturing method of a filament for a 3D printer in which the carbon fiber 400 is impregnated with the thermoplastic resin solution 500 liquefied by a solvent to form a filament in which a thermoplastic resin is evenly penetrated into the carbon fiber 400, and a surface resin layer is formed by applying a thermoplastic resin to the surface of the filament formed in the application of the solvent method by using the extruder 300.

In the above, the exemplary embodiment of the present disclosure has been illustrated and described, but the present disclosure is not limited to the specific embodiment described above. Various modifications of the embodiment may be made by those of ordinary skill in the technical field to which the invention belongs without departing from the gist of the present disclosure claimed in the claims. These modified embodiments should not be individually understood from the technical spirit or prospect of the present disclosure.

What is claimed is:

1. A manufacturing method of a filament for a 3D printer, the method comprising:
forming a filament by covering carbon fiber with a thermoplastic resin; and
forming a resin layer on a surface of the filament, which is formed in the filament forming.

2. The method of claim 1, wherein the filament forming comprises:
liquefying a thermoplastic resin by immersing the thermoplastic resin in a solvent;
impregnating the carbon fiber with a thermoplastic resin solution; and
drying the impregnated carbon fiber obtained in the carbon fiber impregnating.

3. The method of claim 2, wherein the thermoplastic resin is polyamide, and the solvent is formic acid.

4. The method of claim 2, wherein in the drying, the filament obtained in the carbon fiber impregnating is dried by blowing hot air to the filament.

5. The method of claim 1, wherein in the resin layer forming, the resin layer is formed on the surface of the filament formed in the filament forming by extruding a thermoplastic resin from an extruder.

6. The method of claim 5, wherein the resin layer forming is performed by using the extruder in which a conical discharge part is formed continuously on an end part of a cylindrical body, an inlet hole through which a solid thermoplastic resin is supplied is formed in one side of the body, a discharge hole is formed in a longitudinal direction of the extruder in an end part of the discharge part, a through hole is formed in a horizontal direction across the discharge hole, and a rotating screw which is electrically heated is mounted in the body, and
while the filament formed in the filament forming is horizontally moved at a predetermined speed through the through hole, a thermoplastic resin extruded by the screw continuously forms the resin layer on the surface of the filament.
